(19) United States
(12) Patent Application Publication
(10) Pub. No.: US 2026/0212663 A1
(43) Pub. Date: Jul. 23, 2026

(54) CROWD DENSITY ESTIMATION MODEL LEARNING METHOD AND SYSTEM AND CROWD DENSITY ESTIMATION METHOD AND SYSTEM USING THE SAME

(71) Applicant: GWANGJU INSTITUTE OF SCIENCE AND TECHNOLOGY, Gwangju (KR)

(72) Inventors: Ye Chan KIM, Gwangju (KR); Moon Gu JEON, Gwangju (KR)

(73) Assignee: GWANGJU INSTITUTE OF SCIENCE AND TECHNOLOGY, Gwangju (KR)

(21) Appl. No.: 19/454,613

(22) Filed: Jan. 21, 2026

(30) Foreign Application Priority Data
Jan. 21, 2025 (KR) 10-2025-0008645

(51) Int. Cl. G06V 10/82; G06V 20/52

(52) U.S. Cl. CPC G06V 10/82; G06V 20/53

(57) ABSTRACT

A crowd density estimation model learning method, including: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to at least one of the training crowd image and the noise image by using a crowd density estimation model, and deriving a second loss function based on a comparison between the training density map and the ground-truth density map; and training the crowd density estimation model by using the first loss function and the second loss function.

### CROSS REFERENCE TO RELATED APPLICATION

The present application claims priority to Korean Patent Application No. 10-2025-0008645, filed Jan. 21, 2025, the entire contents of which are hereby incorporated by reference for all purposes.

### BACKGROUND

### Field

The present disclosure relates to a crowd density estimation model learning method and system and a crowd density estimation method and system using the same.

### Description of the Related Art

Crowd density estimation is a technology that may grasp in real time, crowds in overcrowded regions and movement patterns of crowds, and, recently, active research has been conducted in the fields of computer vision and urban safety. Such crowd density estimation may be implemented based on deep learning, which is a type of artificial intelligence technologies, and, in this case, deep learning may implement excellent prediction performance when there is sufficient high-quality data regarding crowds.

Typically, a deep learning model, by learning about data samples of at least tens of thousands to millions of images, performs, at a level similar to humans, detection (Localization) of an object of interest in images, thereby enabling a predetermined prediction (Classification) with respect to the object of interest that has been detected.

In this regard, as an example of a dataset for estimating crowd density, ‘UCF_CC_50, Shanghai Tech-Part A, UCF-QNRF, NWPU-Crowd’, and the like have been disclosed. Therefore, together with crowd density estimation in a clear and clean environment based on such datasets, there is a need for a measure capable of estimating crowd density in a noise environment including inclement weather situations.

### SUMMARY

The present invention relates to a crowd density estimation model learning method and system that is capable of quickly and effectively estimating crowd density from images in which crowd has been photographed (captured), and to a crowd density estimation method and system using the same.

In addition, the present invention relates to a crowd density estimation model learning method and system that is capable of effectively estimating crowd density even in situations in which identification of crowd is difficult due to inclement weather, and to a crowd density estimation method and system using the same.

Further, the present invention relates to a crowd density estimation model learning method and system that is capable of grasping in real time crowd density or a change in crowd density according to a temporal flow, and to a crowd density estimation method and system using the same.

A crowd density estimation model learning method and system according to the present invention can solve a problem in which existing crowd counting or density estimation technologies, by excessively depending on limited dataset collected under clear weather conditions, show severe performance degradation with respect to environmental changes such as snow, rain, fog, low illumination, sensor noise, etc. that frequently occur in real urban environments. Such a problem may occur due to a phenomenon in which, even for the same crowd scene, pixel distributions and texture patterns greatly change depending on weather conditions, causing a deep learning model to perform overfitting to weather conditions rather than structural and statistical characteristics of crowd itself.

In addition, in existing technologies, in order to improve generalization performance of a crowd density estimation model, there are many cases in which only simple data augmentation (rotation, cropping, brightness adjustment, etc.) is used, so that a problem may occur in which prediction error in an inclement-weather environment(s) (for example, on a mean absolute error (MAE) basis) significantly increases compared to clear environments. Accordingly, in real-time crowd management systems, it is difficult to appropriately set alarm threshold values based on crowd congestion levels, and a risk of safety incidents due to detection delay or false detection of overcrowded sections may increase.

Further, existing crowd density estimation learning pipelines, because representational consistency between original images and images including noise is not explicitly enforced, may have a problem in which, even though the same crowd scene, when weather conditions change, mappings occur onto different feature spaces. Due to such representational inconsistency, there may exist a limitation in which a feature map inside a network cannot stably reflect physical crowd structures (dense regions, corridor regions, clusters around entrances, etc.).

To solve the aforementioned problems, there is provided a crowd density estimation model learning method, according to the present invention. The crowd density estimation model learning method may comprise: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to at least one of the training crowd image and the noise image by using a crowd density estimation model, and deriving a second loss function based on a comparison between the training density map and the ground-truth density map; and training the crowd density estimation model by using the first loss function and the second loss function.

In addition, there is provided a crowd density estimation model learning system, according to the present invention. The crowd density estimation model learning system may comprise: a storage unit in which a training crowd image and a ground-truth density map labeled to the training crowd image are stored; and a control unit configured to generate a noise image by inserting noise indicating a weather environment into the training crowd image, and to train a crowd density estimation model by using the training crowd image, the ground-truth density map, and the noise image, in which the control unit may: compare, by using a contrastive learning model, features for the training crowd image and the noise image; derive a first loss function based on comparison results; estimate, by using a crowd density estimation model, a training density map corresponding to at least one of the training crowd image and the noise image; derive a second loss function based on a comparison between the training density map and the ground-truth density map; and train, by using the first loss function and the second loss function, the crowd density estimation model.

In addition, there is provided a program stored on a computer-readable recording medium that is executed by one or more processes in an electronic device, according to the present invention. The program may comprise instructions for performing: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to at least one of the training crowd image and the noise image by using a crowd density estimation model, and deriving a second loss function based on a comparison between the training density map and the ground-truth density map; and training the crowd density estimation model by using the first loss function and the second loss function.

In addition, there is provided a crowd density estimation method, according to the present invention. The crowd density estimation method may comprise: receiving a crowd image; and estimating a density map for crowd appearing in the crowd image by inputting the crowd image to a pre-trained crowd density estimation model, in which the pre-trained crowd density estimation model may be trained according to a crowd density estimation model learning method, and the crowd density estimation model learning method may comprise: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to the training crowd image by using a crowd density estimation model, and deriving a second loss function based on a comparison between the training density map and the ground-truth density map; and training the crowd density estimation model by using the first loss function and the second loss function.

In addition, there is provided a crowd density estimation system, according to the present invention. The crowd density estimation system may comprise: a storage unit in which a crowd image is stored; and a control unit configured to estimate a density map for crowd appearing in the crowd image, by inputting the crowd image to a pre-trained crowd density estimation model, in which the pre-trained crowd density estimation model may be trained according to a crowd density estimation model learning method, and the crowd density estimation model learning method may comprise: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to the training crowd image by using a crowd density estimation model, and deriving a second loss function based on a comparison between the training density map and the ground-truth density map; and training the crowd density estimation model by using the first loss function and the second loss function. In addition, there is provided a program stored on a computer-readable recording medium that is executed by one or more processes in an electronic device, according to the present invention. The program may comprise instructions for performing: receiving a crowd image; and estimating a density map for crowd appearing in the crowd image, by inputting the crowd image to a pre-trained crowd density estimation model, in which the pre-trained crowd density estimation model may be trained according to a crowd density estimation model learning method, and the crowd density estimation model learning method may comprise: receiving a training crowd image and a ground-truth density map labeled to the training crowd image, and generating a noise image by inserting noise indicating a weather environment into the training crowd image; comparing features for the training crowd image and the noise image by using a contrastive learning model, and deriving a first loss function based on comparison results; estimating a training density map corresponding to the training crowd image by using a crowd density estimation model, and deriving a second loss function based on a comparison between the training density map and the ground-truth density map; and training the crowd density estimation model by using the first loss function and the second loss function.

According to various embodiments of the present invention, the crowd density estimation model learning method and system, and the crowd density estimation method and system using the same, by training a crowd density estimation model using images in which crowd has been photographed (captured) and a density map regarding crowd in the corresponding images, may quickly and effectively estimate crowd density from images in which crowd has been photographed.

In addition, according to various embodiments of the present invention, the crowd density estimation model learning method and system, and the crowd density estimation method and system using the same, by inserting noise due to inclement weather such as snow, rain, fog, etc. into crowd images and training a crowd density estimation model so that respective features of crowd images and images into which noise has been inserted become similar, may effectively estimate crowd density even in situations in which identification of crowd is difficult due to inclement weather.

In addition, according to various embodiments of the present invention, the crowd density estimation model learning method and system, and the crowd density estimation method and system using the same, by generating a density map corresponding to images in which crowd has been photographed using a crowd density estimation model that has been pre-trained, may grasp in real time crowd density or a change in crowd density according to temporal flow.

For example, in an embodiment according to the present invention, with respect to public datasets widely used for crowd density estimation such as ShanghaiTech-Part A, UCF-QNRF, and NWPU-Crowd, performance of a comparison model trained based on clear-environment images may be compared with that of a model to which noise images and contrastive learning according to the present invention are simultaneously applied. In such a comparison, for a validation set to which strong blur, illumination degradation, and artificial weather noise are added, a model according to the present invention, on a mean squared error (MSE) and mean absolute error (MAE) basis, may reduce error by about 5% to 30% compared to existing models.

In addition, when the crowd density estimation model according to the present invention is mounted on a real-time CCTV system of a city control center, by using GPU or NPU acceleration for an input stream at a level of 10 to 30 frames per second per camera, a density map may be generated with inference latency within tens of milliseconds (ms) per frame, so that a region exceeding a crowd density threshold value may be detected and an alarm may be generated within 1 second. As such, the embodiments of the present invention, beyond simple statistical prediction improvement, may simultaneously secure processing speed and robustness at a level available for real-time utilization in actual safety-management and traffic-management scenarios.

The present invention is not directed merely to analyzing crowd images or producing a numerical estimation result, but to improving internal operation of a crowd density estimation system by stabilizing feature responses under varying environmental conditions without increasing computational complexity during inference.

In particular, the invention modifies how a computer vision system generates and reuses internal feature representations for density estimation, thereby improving robustness of density map generation in real-world environments.

### BRIEF DESCRIPTION OF THE DRAWINGS

FIG. 1 illustrates an embodiment of training a crowd density estimation model according to the present invention.

FIG. 2 illustrates a crowd density estimation model learning system according to the present invention.

FIG. 3 is a flowchart showing a crowd density estimation model learning method according to the present invention.

FIG. 4 illustrates an embodiment of generating a noise image.

FIG. 5 illustrates an embodiment of generating a first feature vector and a second feature vector.

FIG. 6 illustrates an embodiment of deriving a first loss function.

FIG. 7 illustrates an embodiment of deriving a second loss function.

FIG. 8 illustrates an embodiment of training the crowd density estimation model.

FIG. 9 illustrates a crowd density estimation system according to the present invention.

FIG. 10 is a flowchart showing a crowd density estimation method according to the present invention.

FIG. 11 illustrates an embodiment of estimating a density map using the crowd density estimation model.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including”, “having”, and the like are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

Major terms used in the present specification may be defined as follows.

(1) “A crowd image” or “a crowd image 60” may mean two-dimensional or three-dimensional image data acquired by one or more cameras or image sensors, as a still image(s) or an individual frame(s) of a moving image in which a plurality of human objects are included within the same frame. The crowd image may be stored in memory in a tensor form including one or more of RGB color channels, infrared channels, depth channels, and the like. (2) “A ground-truth density map 11” may be defined as a two-dimensional matrix including scalar values indicating a crowd congestion degree for each pixel or for each cell region of a predetermined size on the crowd image. The density map generated by the crowd density estimation model is not limited to a visualization output, but is structured as a machine-readable data object used as an input for subsequent computational processes including congestion detection, threshold comparison, and control signal generation in a crowd management system.

For example, a total sum of the ground-truth density map may be normalized to correspond to a total number of persons in the corresponding image. (3) “A noise image 13” may mean a transformed image generated by applying an image representing a weather environment(s) or image processing operations such as blur, illumination change, resolution degradation, etc. to a training crowd image. The noise image may be generated to maintain the same resolution and channel configuration as an original crowd image. (4) “A first feature vector 41” and “a second feature vector 42” are intermediate representations after passing through a feature extraction module 21 of a crowd density estimation model, and may mean a tensor or a one-dimensional vector mapping spatial and statistical patterns of an input image to a high-dimensional space. (5) “A first loss function 51” is a loss that quantifies representational similarity between a training crowd image and a noise image in a contrastive learning manner, and may be implemented as a margin-based loss based on a label y for an image pair, a distance between feature vectors, and a reference distance m, or as an InfoNCE-family loss. “A second loss function 52” is a loss that quantifies an error between a training density map and the ground-truth density map, and may be implemented as MSE, MAE, cross-entropy, or a combination thereof. “A third loss function 53” is a final training objective function obtained by a weighted sum of the first loss function and the second loss function, and may adjust contributions of the two losses according to a value of a weight a. (6) “A contrastive learning model 30” is a neural network trained to receive, as input, a pair of feature vectors and output a similarity value reflecting whether the pair of feature vectors is a same scene (Positive Pair) or a different scene (Negative Pair), and may be configured with a dimension reduction module and a projection head.

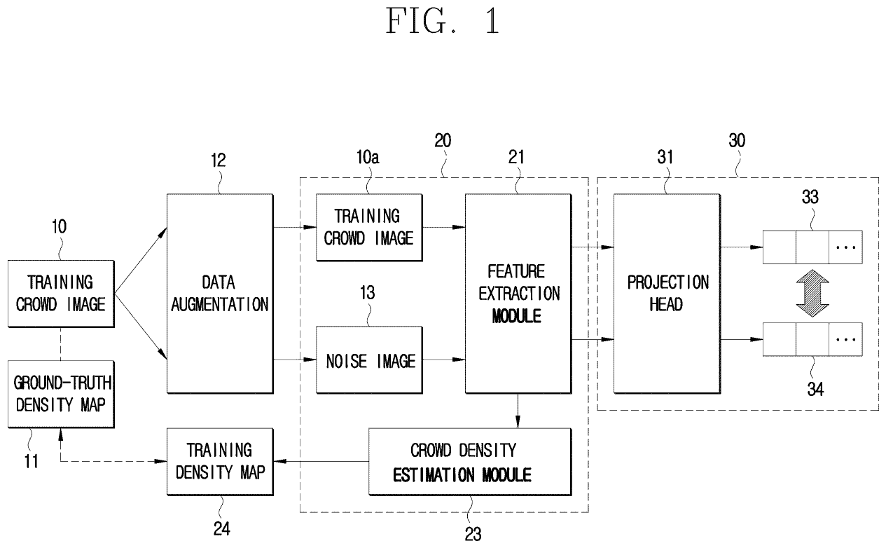

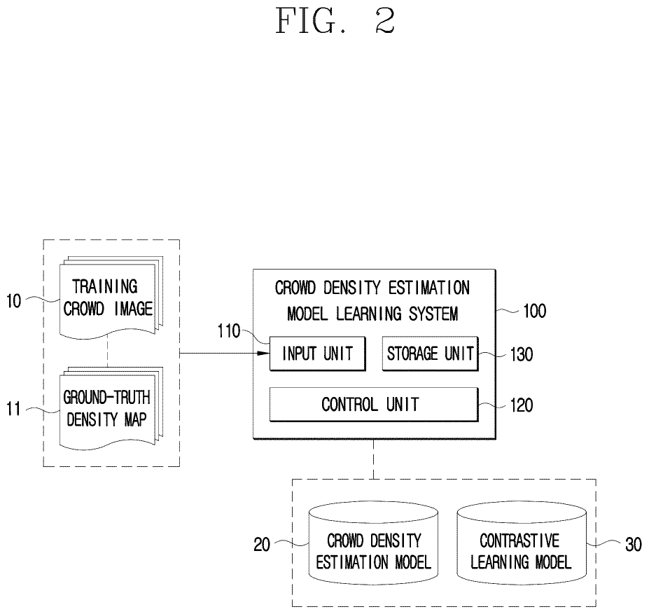

FIG. 1 illustrates an embodiment of training a crowd density estimation model according to the present invention. FIG. 2 illustrates a crowd density estimation model learning system according to the present invention.

With reference to FIG. 1, a crowd density estimation model learning system 100 according to the present invention, may generate a noise image 13 by inserting noise representing a weather environment(s) into a training crowd image 10 labeled with a ground-truth density map 11, and by using comparison results for respective features of the training crowd image 10 and the noise image 13 based on a contrastive learning model 30, and comparison results for a training density map 24 generated based on a crowd density estimation model 20 and the ground-truth density map 11, may train the crowd density estimation model 20.

The training crowd image 10 may be an image provided to train the crowd density estimation model 20, and such a training crowd image 10 may be an image in which crowd has been photographed (captured). In this case, the training crowd image 10 may be photographed so that crowd may be relatively clearly distinguished. In this regard, the training crowd image 10 may also be used as a training crowd image 10a adjusted through data augmentation 12 in a process of training the crowd density estimation model 20. For example, the adjusted training crowd image 10a, for the data augmentation 12 for the training crowd image 10, may be one to which image processing such as left-right inversion, rotation, scale adjustment, up-down inversion, etc. is applied. However, it is obvious that a training crowd image 10, to which the data augmentation 12 is not applied, may also be used in a process of training the crowd density estimation model 20.

The ground-truth density map 11 is an image labeled to the training crowd image 10, and may be one indicating crowd density in the training crowd image 10. That is, the ground-truth density map 11 may be provided to be able to distinguish a region corresponding to a crowd and a non-crowd region in the training crowd image 10.

The noise image 13 may be an image into which noise representing a weather environment(s) is inserted into the training crowd image 10. That is, the noise image 13 may be one generated through the data augmentation 12 for the training crowd image 10. Here, weather environments may include snow, rain, fog, and the like, and may be elements that make it difficult to identify a target object on a predetermined image. Accordingly, the noise image 13, as an element that makes it difficult to identify a region in which a crowd exists in the training crowd image 10, may be one into which noise is inserted, and, in this case, noise applied to the noise image 13 may include blur, illumination change, resolution change, and the like, and, according to embodiments, may include an image of a transparent background representing a weather environment(s).

The crowd density estimation model 20, when a predetermined crowd image is input, may be implemented to generate a feature vector corresponding to the crowd image and, based on the generated feature vector, to generate a density map. Therefore, the crowd density estimation model 20 may be trained such that, when a training crowd image 10a is input, a feature vector corresponding to the training crowd image 10 is generated and a loss function between the training density map 24 generated based on the generated feature vector and the ground-truth density map 11 becomes minimized. To this end, the crowd density estimation model 20 may be implemented as a deep learning model such as Convolutional Neural Network (CNN), Transformer, Mamba, etc.

The contrastive learning model 30 may be implemented to compare features for the training crowd image 10 and the noise image 13 and to calculate a similarity between the training crowd image 10 and the noise image 13. To this end, the contrastive learning model 30 may be implemented to convert a feature vector generated from the crowd density estimation model 20 into a one-dimensional feature vector suitable for contrastive learning, and to calculate a similarity by comparing two different feature vectors converted into one dimension.

In this case, the contrastive learning model 30 may be pre-trained based on a large-scale dataset, or primary training may be performed using a plurality of training crowd images 10 and a plurality of noise images 13.

For example, the crowd density estimation model learning system 100 may generate a pair of a training crowd image 10 and a noise image 13 by matching the training crowd image 10 and the noise image 13 generated based on the training crowd image 10, and may label to the pair of the training crowd image 10 and the noise image 13, as labeling data indicating a similarity between the training crowd image 10 and the noise image 13, a value indicating that the images are similar (for example, 1).

In an embodiment, a control unit 130 may first perform resolution normalization and preprocessing for a training crowd image. For example, the control unit 130 may resize a size of each training crowd image to a fixed resolution of W×H, normalize pixel values to intervals of [0, 1] or [-1, 1], and then perform normalization (standardization) using channel-wise means and standard deviations. Subsequently, the control unit 130, according to a batch size B, may load into memory in a tensor form a plurality of training crowd images and corresponding ground-truth density maps, and, by applying data augmentation (left-right inversion, random crop, color distortion, etc.) within the same batch, may allow a model to be generalized to diverse observation conditions.

In step S200, the control unit 130 may generate at least one noise image for each training crowd image in a batch and, after configuring a pair(s) of a training crowd image(s) and a noise image(s) as a Positive Pair(s) and a pair(s) of a different crowd image(s) and a noise image(s) based thereon as a Negative Pair(s), may use such pairs as inputs to the contrastive learning model. In this case, a label y for each pair is set to 1 for a Positive Pair and to 0 for a Negative Pair, and the control unit 130, by calculating a distance d(zᵢ, zⱼ) of a pair-wise feature vector, may calculate a first loss function by using y, d (zᵢ, zⱼ), and a reference distance m.

In addition, the crowd density estimation model learning system 100 may generate a pair of a training crowd image 10 and a noise image 13 by matching the training crowd image 10 and the noise image 13 generated based on an image different from the training crowd image 10, and may label to the pair of the training crowd image 10 and the noise image 13, as labeling data indicating a similarity between the training crowd image 10 and the noise image 13, a value indicating that the images are not similar (for example, 0).

Accordingly, the crowd density estimation model learning system 100, by using pairs of a plurality of training crowd image 10 and noise image 13 and labeling data labeled to respective pairs, may train the contrastive learning model 30.

Meanwhile, with reference to FIG. 2, the crowd density estimation model learning system 100 according to the present invention may include an input unit 110, a storage unit 120, and a control unit 130. The input unit 110, the storage unit 120, and the control unit 130 may be connected to one another through a system bus, a network, or other connection mechanisms.

Information necessary for operation of the crowd density estimation model learning system 100 according to the present invention may be input to the input unit 110, To this end, the input unit 110 may be connected with a separate input device, a server, or an external storage device, etc., via a wireless or a wired network. For example, predetermined information may be input to the input unit 110 based on a touch screen, a computer mouse, a keyboard, a keypad, a touch pad, a trackball, a joystick, a voice recognition module, other similar devices, or the like.

In an embodiment, the crowd density estimation model learning system 100 may be implemented as a server system connected with one or more camera devices via a wired/wireless network. A camera device may be a fixed-type CCTV, a PTZ (pan tilt zoom) camera, a mobile vehicle-mounted camera, or a drone camera, and each camera device may transmit a crowd image(s) to a training server via communication interfaces such as Ethernet, 5G, Wi-Fi, and optical communication, etc. A training server may be configured as a rack-mount server or a cloud computing node including a CPU, a GPU, main memory, and large-capacity storage, and a GPU or an NPU, by processing in parallel a crowd density estimation model based on CNN, Transformer, and Mamba and a contrastive learning model, may perform batch training for a large-scale dataset at high speed.

In another embodiment, the input unit 110 may include a network interface card (NIC) and a data collection module, divide real-time video streams received by Real Time Streaming Protocol (RTSP) or HTTP-based streaming into frame-unit crowd images, and record, together with frame-wise metadata (shooting (capturing) time, camera ID, position information), in the storage unit 120. By implementing in this manner, crowd images and corresponding ground-truth density maps and noise images may be efficiently retrieved and utilized for training based on temporal and spatial indices.

Accordingly, the input unit 110 may receive a training crowd image 10 and a ground-truth density map 11 from a separate input device, a server, or an external storage device, etc. In addition, the input unit 110 may receive various information required in a process of training the crowd density estimation model 20 based on a training crowd image 10 and a ground-truth density map 11.

In addition, instructions and information necessary for operation of the crowd density estimation model learning system 100 according to the present invention may be stored in the storage unit 120. Such a storage unit 120, as data storage, may include one or more non-transitory computer-readable storage media that may be read and/or accessed by the control unit 130 (for example, at least one of one or more processors).

One or more non-transitory computer-readable storage media may include volatile and/or non-volatile storage constituent elements such as optical, magnetic, organic, or other memory or disk storage devices. In some examples, the storage unit 120 may be implemented using a single physical device (for example, one optical, magnetic, organic, or other memory or disk storage device), whereas in other examples, the storage unit 120 may be implemented using two or more physical devices.

In addition, the storage unit 120 may include computer-readable instructions (directives) and additional data. The storage unit 120 may include storage necessary to perform at least a part of methods, scenarios, and techniques described in the present specification and/or at least a part of functions of devices and networks.

Accordingly, a training crowd image 10 and a ground-truth density map 11 input through the input unit 110 may be stored in the storage unit 120. In addition, a noise image generated based on a training crowd image 10 may be stored in the storage unit 120. In addition, in the storage unit 120, the crowd density estimation model 20 and the contrastive learning model 30 may be stored, and, in a process of training the crowd density estimation model 20, various data generated from the crowd density estimation model 20 and the contrastive learning model 30 respectively may be stored.

The control unit 130 may control the overall operation of the crowd density estimation model learning system 100 according to the present invention. Such a control unit 130, as one or more processors, may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), etc.). The control unit 130 may be configured to execute computer-readable instructions (directives) included in the storage unit 120 and/or other commands described in the present specification.

Accordingly, the control unit 130, by inserting noise representing a weather environment(s) into a training crowd image 10 labeled with a ground-truth density map 11 to generate a noise image, and by using comparison results for respective features of the training crowd image 10 and the noise image based on the contrastive learning model 30, and comparison results for a training density map generated based on the crowd density estimation model 20 and the ground-truth density map 11, may train the crowd density estimation model 20.

Specifically, the control unit 130 may receive a training crowd image 10 and a ground-truth density map 11 labeled to the training crowd image 10, and may generate a noise image by inserting noise representing a weather environment(s) into the training crowd image 10.

To this end, the control unit 130, by simulating a weather environment(s) for the training crowd image 10, may apply predetermined single or multiple noises, and may label the ground-truth density map 11 to a noise image generated with noise applied.

Accordingly, the control unit 130, using the contrastive learning model 30, may compare features for the training crowd image 10 and the noise image, and may derive a first loss function based on comparison results.

To this end, the control unit 130, by inputting the training crowd image 10 and the noise image respectively to the crowd density estimation model 20, may generate a first feature vector corresponding to the training crowd image 10 and a second feature vector corresponding to the noise image.

In addition, the control unit 130, by inputting the first feature vector and the second feature vector to the contrastive learning model 30, may generate a similarity value indicating similarity between the first feature vector and the second feature vector.

Through this, the control unit 130, based on the similarity value for the first feature vector and the second feature vector, may derive a first loss function according to a difference between the first feature vector and the second feature vector.

Meanwhile, the control unit 130, by using the crowd density estimation model 20, may estimate a training density map corresponding to the training crowd image 10, and may derive a second loss function based on a comparison between the training density map and the ground-truth density map 11.

To this end, the control unit 130, through the crowd density estimation model 20, may generate a training density map corresponding to at least one of the first feature vector and the second feature vector generated earlier, and, by comparing the training density map and the ground-truth density map 11, may derive a second loss function.

Accordingly, the control unit 130, using the first loss function and the second loss function, may train the crowd density estimation model 20. That is, the control unit 130 may assign a predetermined weight to the first loss function, and derive a third loss function by using the first loss function to which the weight is assigned and the second loss function, and may train the crowd density estimation model 20 by using the third loss function.

Based on a configuration of the crowd density estimation model learning system 100 described above, a crowd density estimation model learning method will be described below in more detail.

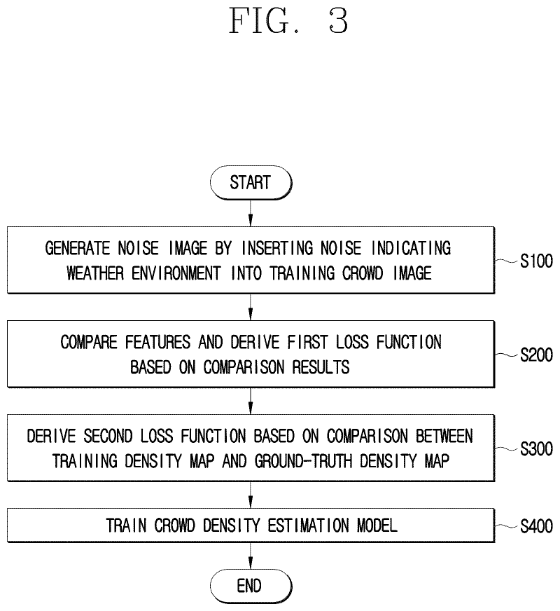

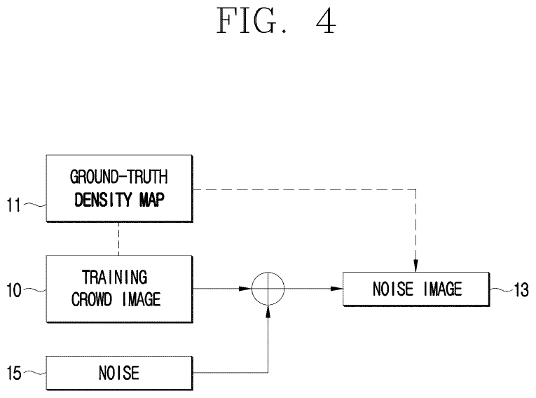

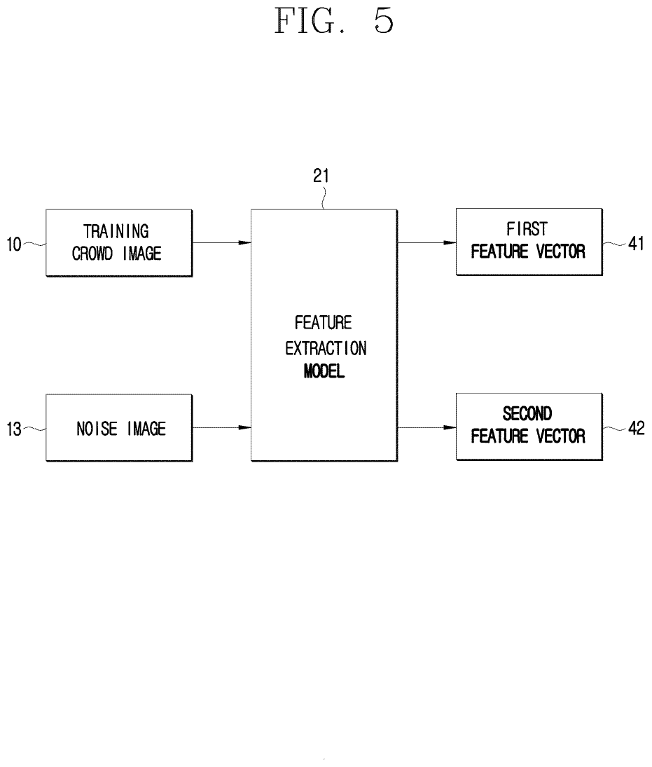

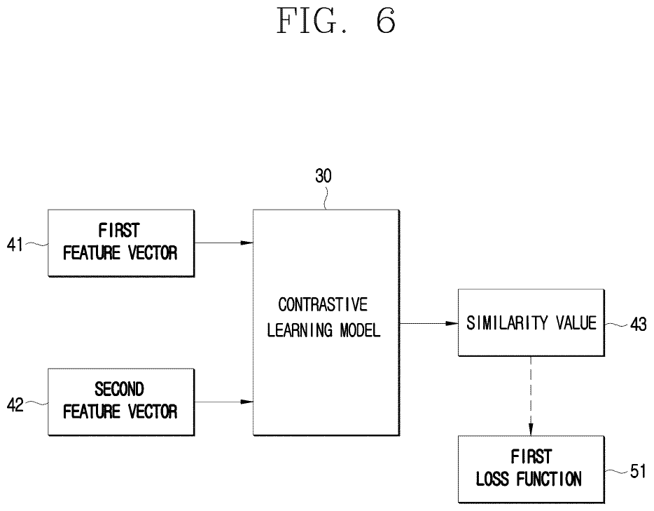

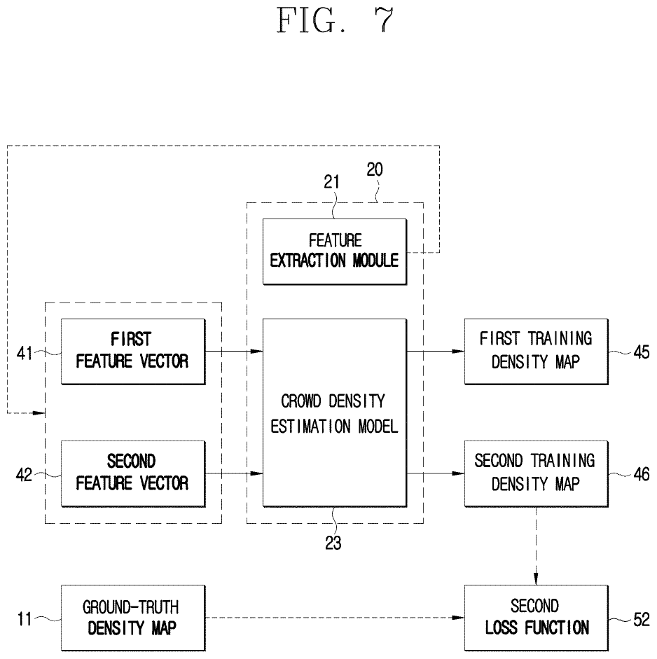

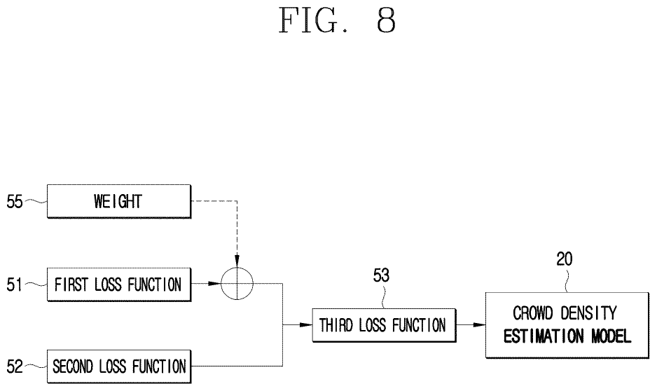

FIG. 3 is a flowchart showing a crowd density estimation model learning method according to the present invention. FIG. 4 illustrates an embodiment of generating a noise image. FIG. 5 illustrates an embodiment of generating a first feature vector and a second feature vector. FIG. 6 illustrates an embodiment of deriving a first loss function. FIG. 7 illustrates an embodiment of deriving a second loss function. FIG. 8 illustrates an embodiment of training the crowd density estimation model.

With reference to FIG. 3, the crowd density estimation model learning system 100 according to the present invention may receive a training crowd image and a ground-truth density map labeled to the training crowd image, and may generate a noise image by inserting noise representing a weather environment(s) into the training crowd image (S100).

Specifically, the crowd density estimation model learning system 100, by simulating a weather environment(s) for the training crowd image, may apply predetermined single or multiple noises, and may label the ground-truth density map to the noise image generated with noise applied.

With reference to FIG. 4, for example, the crowd density estimation model learning system 100 may be provided with a weather image that simulates weather environments such as snow, rain, fog, etc. In this case, the weather image may be a backgroundless image (that is, a transparent-background image), or may be an image having a predetermined transparency. Accordingly, the crowd density estimation model learning system 100 may generate a noise image 13 by superimposing at least one weather image as a noise 15 onto a training crowd image 10. Accordingly, the crowd density estimation model learning system 100 may label to the noise image 13 the ground-truth density map 11 that is labeled to the training crowd image 10.

In this case, the crowd density estimation model learning system 100 may generate the noise image 13 corresponding to the training crowd image 10, and may convert the training crowd image 10 into left-right symmetry, and may use the noise image 13 and the left-right symmetric training crowd image 10 for training of a crowd density estimation model.

In another example, the crowd density estimation model learning system 100 may be provided with one or more predetermined image processing methods corresponding to a different weather environment(s). In this case, the image processing method may include blur, illumination change, resolution change, etc. Accordingly, the crowd density estimation model learning system 100 may generate a noise image by superimposing at least one image processing method on at least a partial region on a training crowd image.

In another example, the crowd density estimation model learning system 100 may also generate a noise image corresponding to a training crowd image by using a generative adversarial network (GAN) or a diffusion model.

To this end, the generative adversarial network or the diffusion model, when a training crowd image (and noise data) is input, may be trained to generate a noise image with a predetermined weather environment added to the training crowd image.

With reference back to FIG. 3, the crowd density estimation model learning system 100 according to the present invention, by using a contrastive learning model, may compare features for a training crowd image and a noise image, and may derive a first loss function based on comparison results (S200).

Specifically, the crowd density estimation model learning system 100, by inputting a training crowd image and a noise image respectively to a crowd density estimation model, may generate a first feature vector corresponding to the training crowd image and a second feature vector corresponding to the noise image.

With reference to FIG. 5, for example, the crowd density estimation model, when a predetermined image is input, may include a feature extraction module 21 that generates a feature vector corresponding to the input image, and a crowd density estimation module that generates a density map corresponding to the feature vector. In this case, the feature extraction module 21 may be configured as an encoder or a convolutional layer.

Accordingly, the crowd density estimation model learning system 100, by inputting respectively a training crowd image 10 and a noise image 13 to the feature extraction module 21 provided in a crowd density estimation model, may acquire respectively a first feature vector 41 and a second feature vector 42 generated from the feature extraction module 21.

Further, the crowd density estimation model learning system 100, by inputting the first feature vector and the second feature vector to a contrastive learning model, may generate a similarity value indicating similarity between the first feature vector and the second feature vector.

For example, a contrastive learning model, when a feature vector composed of three dimensions (for example, the first feature vector and the second feature vector) is input, may generate a two-dimensional feature vector by reducing a dimension of the input feature vector, may convert the two-dimensional feature vector into a one-dimensional feature vector constructed according to contrastive learning, and may compare different feature vectors converted into one dimension.

To this end, the contrastive learning model may include a dimension reduction module and a projection head. Here, the dimension reduction module, when a feature vector composed of three dimensions is input, may be implemented to generate a two-dimensional feature vector by reducing a dimension of the input feature vector.

In an embodiment, the dimension reduction module may be implemented to unfold a feature vector composed of three dimensions to generate a two-dimensional array. That is, the dimension reduction module, when a three-dimensional feature vector is composed of height, width, and channels, by connecting (concatenating) arrays having height and width in each of a plurality of channels to an array corresponding to a single channel (for example, a first channel), may convert the three-dimensional feature vector into a two-dimensional feature vector.

In another embodiment, the dimension reduction module may be implemented to unfold a feature vector composed of three dimensions to generate a two-dimensional array, and to convert the two-dimensional array into a two-dimensional (or, a one-dimensional) feature vector by using a fully connected neural network having one or more hidden layers.

In still another embodiment, the dimension reduction module may be implemented to apply global average pooling to a three-dimensional feature vector, and to generate a two-dimensional (or, a one-dimensional) feature vector by applying a nonlinear function such as a connection neural network, etc. to a result according to global average pooling.

In addition, the projection head may convert a first feature vector and a second feature vector converted into two dimensions (or, one dimension) in the dimension reduction module into a one-dimensional feature vector constructed according to contrastive learning, may compare the first feature vector and the second feature vector converted into one dimension, and may generate a similarity value according to comparison results.

To this end, the projection head may include a fully connected neural network. Accordingly, the projection head, when a predetermined feature vector is input, may convert the feature vector into a one-dimensional feature vector suitable for contrastive learning. In addition, the projection head may calculate a distance between two different feature vectors converted by the fully connected neural network, and may derive a similarity value according to calculation results.

Accordingly, the crowd density estimation model learning system 100, by inputting the first feature vector and the second feature vector generated from the crowd density estimation model to the dimension reduction module, may convert respectively the first feature vector and the second feature vector into a two-dimensional (or, a one-dimensional) first feature vector and a two-dimensional (or, a one-dimensional) second feature vector, and, by inputting the converted first feature vector and the converted second feature vector to the projection head, may convert respectively the first feature vector and the second feature vector into a one-dimensional first feature vector and a one-dimensional second feature vector, and, by calculating a distance between the converted first feature vector and the converted second feature vector, may generate a similarity value.

Meanwhile, the contrastive learning model may also be configured such that the dimension reduction module and the projection head are integrated into a single module. In such a case, the contrastive learning model, when a first feature vector and a second feature vector generated from a crowd density estimation model are input, may be implemented to convert respectively the first feature vector and the second feature vector into a one-dimensional feature vector, and to generate a similarity value by calculating a distance between the converted first feature vector and the converted second feature vector.

Further, the crowd density estimation model learning system 100, based on a similarity value for the first feature vector and the second feature vector, may derive a first loss function according to a difference between the first feature vector and the second feature vector.

With reference to FIG. 6, for example, the crowd density estimation model learning system 100 may calculate a similarity value 43 for each of a plurality of training crowd image and noise image pairs generated based on a plurality of training crowd images. Accordingly, the crowd density estimation model learning system 100, by using a plurality of similarity values 43 calculated based on a plurality of training crowd images, may derive a first loss function 51.

In an embodiment, the crowd density estimation model learning system 100 may derive a first loss function 51 by using Equation 1 below.

$$L = \frac{1}{N} {\sum }_{i = 1}^{N} [ y \cdot {\vert {z}_{i} - {z}_{j} \vert}^{2} + ( 1 - y ) \cdot {max ( 0 , m - \vert {z}_{i} - {z}_{j} \vert )}^{2} ] \qquad Equation 1$$

Here, L denotes a first loss function 51, N denotes the number of a plurality of training crowd images, and y, as labeling data for a pair of a training crowd image and a noise image, may be data indicating whether the pair of the training crowd image and the noise image are similar. That is, when a noise image corresponding to a pair of a training crowd image and a noise image is generated based on a training crowd image corresponding to the pair of the training crowd image and the noise image, labeling data for the pair of the training crowd image and the noise image is set to 1, and when the noise image corresponding to the pair of the training crowd image and the noise image is generated based on an image different from the training crowd image corresponding to the pair of the training crowd image and the noise image, labeling data for the pair of the training crowd image and the noise image may be set to 0.

In addition, zᵢ denotes a first feature vector 41 converted into one dimension, zⱼ denotes a second feature vector 42 converted into one dimension, and, in an embodiment, a difference between the first feature vector 41 converted into one dimension and the second feature vector 42 converted into one dimension may be a similarity value generated earlier by the contrastive learning model. In addition, m, as a predetermined reference distance value, may indicate a minimum distance to be trained for an image pair for which labeling data is set to 0.

In an embodiment, the control unit 130, in a specific form of Equation 1, may define a contrastive loss function as a margin-based loss as follows. For example, when y is 1, by minimizing a d(zᵢ, zⱼ)² term, a distance of Positive Pair may be made close to 0, and when y is 0, by minimizing a max(0,m−d(zᵢ, zⱼ))2 term, a distance of Negative Pair may be trained to be at least m. In this case, m may be selected as a value between 0.5 and 2.0, and a value of m may be empirically set in consideration of a contrastive learning convergence speed and crowd density estimation performance on a validation dataset.

With reference back to FIG. 3, the crowd density estimation model learning system 100 according to the present invention, by using the crowd density estimation model, may estimate a training density map corresponding to at least one of a training crowd image and a noise image, and may derive a second loss function based on a comparison between the training density map and a ground-truth density map (S300). Specifically, the crowd density estimation model learning system 100, through the crowd density estimation model, may generate a training density map corresponding to at least one of the first feature vector and the second feature vector generated earlier, and, by comparing the training density map and the ground-truth density map, may derive the second loss function.

For example, the crowd density estimation model learning system 100, through a crowd density estimation module provided in the crowd density estimation model, may generate a training density map corresponding to either the first feature vector or the second feature vector. In this case, the crowd density estimation module, when a feature vector generated from the feature extraction module is input, may be implemented to generate a density map corresponding to the input feature vector, and, according to embodiments, the crowd density estimation module may be deep learning models such as CNN, Transformer, Mamba, etc.

Accordingly, the crowd density estimation model learning system 100 may compare the training density map and the ground-truth density map, and may derive the second loss function based on a difference according to comparison results. In this case, the crowd density estimation model learning system 100, by comparing the training density map and the ground-truth density map in various manners such as mean squared error (MSE), mean absolute error (MAE), cross-entropy loss, etc., may derive the second loss function.

With reference to FIG. 7, in another example, the crowd density estimation model learning system 100, through the crowd density estimation model 20, may generate a first training density map 45 corresponding to a first feature vector 41 and a second training density map 46 corresponding to a second feature vector 42. In such a case, the crowd density estimation model learning system 100, by comparing the first training density map 45 and the ground-truth density map 11, may derive a second-first loss function, and, by comparing the second training density map 46 and the ground-truth density map 11, may derive a second-second loss function.

Accordingly, the crowd density estimation model learning system 100 may specify a second loss function 52 based on at least one of the second-first loss function and the second-second loss function.

In an embodiment, the crowd density estimation model learning system 100 may specify, as the second loss function 52, a loss function that represents a relatively large difference among the second-first loss function and the second-second loss function.

In another embodiment, the crowd density estimation model learning system 100, by calculating an average between the second-first loss function and the second-second loss function, may derive the second loss function 52.

In still another example, the crowd density estimation model learning system 100, through a crowd density estimation model, may generate a plurality of training density maps corresponding respectively to a first feature vector and a second feature vector. In such a case, the crowd density estimation model learning system 100, by comparing respectively a plurality of training density maps and a ground-truth density map and by integrating comparison results, may derive a second loss function. That is, the crowd density estimation model learning system 100, by using a training crowd image and a noise image as a single dataset, may derive a loss function for the corresponding dataset as the second loss function.

With reference back to FIG. 3, the crowd density estimation model learning system 100 according to the present invention, by using a first loss function and a second loss function, may train the crowd density estimation model (S400).

Specifically, the crowd density estimation model learning system 100, by assigning a predetermined weight to the first loss function, and by deriving a third loss function using the first loss function to which the weight is assigned and the second loss function, and by using the third loss function, may train the crowd density estimation model.

With reference to FIG. 8, for example, the crowd density estimation model learning system 100 may calculate a third loss function 53 according to Equation 2 below.

$${L}_{final} = {L}_{d e n} + α {L}_{c o n} \qquad Equation 2$$

Here, L_{final} denotes a third loss function 53, L_{den} denotes a second loss function 52, and Lcon may denote a first loss function 51. In addition, α may denote a predetermined weight 55. In this case, the predetermined weight 55 may be determined to prevent a bias due to the first loss function 51 or the second loss function 52.

The control unit 130, by setting a weight a to a value greater than 0 and less than 1 in a third loss function L_{final}=L_{den}+α L_{con}, may adjust a balance between density estimation accuracy and representational consistency. For example, in an initial training stage, a may be set to 0.5 or higher to make a contribution of contrastive learning relatively high so that a model forms a stable feature space under diverse weather environments, and, in a later training stage, a may be decreased to 0.1 to 0.3 to place a greater emphasis on reducing a density estimation error L_{den}. In addition, the control unit 130, by applying Adam or AdamW as an optimizer and by setting hyper-parameters such as a learning rate, a momentum, a weight decay coefficient, etc., may control a training procedure so that a gradient of the third loss function decreases stably.

Accordingly, the crowd density estimation model learning system 100, by calculating a gradient of the third loss function 53 with respect to parameters included in the crowd density estimation model 20 and by deriving parameters at which the gradient of the third loss function 53 becomes minimized, may train the crowd density estimation model 20.

In this case, parameters included in the crowd density estimation model, as parameters included in deep learning models such as CNN, Transformer, Mamba, etc., may mean trainable parameters.

In this regard, the crowd density estimation model learning system 100 may perform learning separately for a feature extraction module and a crowd density estimation module provided in the crowd density estimation model 20, or may perform learning integrated for the feature extraction module and the crowd density estimation module.

In an embodiment, the crowd density estimation model learning system 100, based on the third loss function 53, may train a feature extraction module, and, when learning for the feature extraction module is completed, may train a crowd density estimation module based on the second loss function 52 based on a training crowd image (and/or a noise image) and a ground-truth density map.

In another embodiment, the crowd density estimation model learning system 100 may train a feature extraction module and a crowd density estimation module based on the third loss function 53.

Through the configurations as described above, the crowd density estimation model learning system 100, by training a crowd density estimation model using an image in which crowd is photographed and a density map for the crowd in the corresponding image, may rapidly and effectively estimate crowd density from an image in which crowd is photographed.

In addition, the crowd density estimation model learning system 100, by inserting noise due to inclement weather such as snow, rain, fog, etc. into a crowd image and by training a crowd density estimation model so that features of the crowd image and an image into which noise is inserted become similar, may effectively estimate crowd density even in situations in which identifying crowd is difficult due to inclement weather.

Meanwhile, the crowd density estimation system 200 according to the present invention may estimate a density map from a crowd image by using a crowd density estimation model trained by the crowd density estimation model learning system 100.

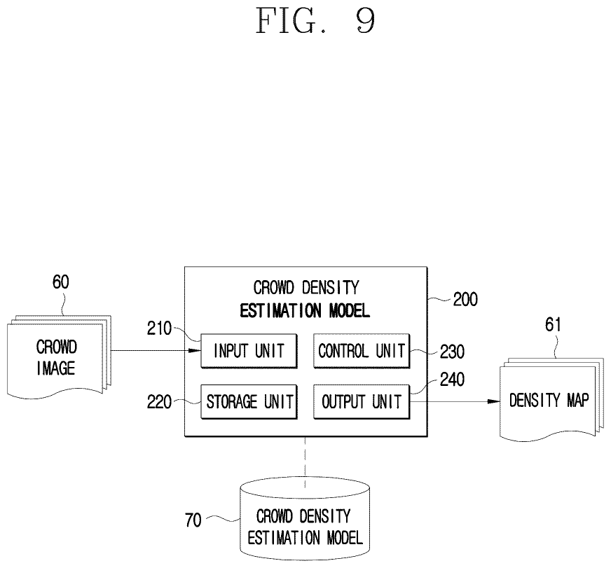

Hereinafter, with reference to FIG. 9, the crowd density estimation system 200 according to the present invention will be described in more detail. FIG. 9 illustrates a crowd density estimation system according to the present invention.

With reference to FIG. 9, the crowd density estimation system 200, by inputting crowd images 60 to a pre-trained crowd density estimation model 70, may estimate a density map 61 for a crowd appearing in the crowd image 60.

Here, the crowd image(s) 60, as an image(s) in which a crowd is photographed, may include an image photographed in a clear environment and an image in which noise occurs due to inclement weather such as snow, rain, fog, etc., and may also include an image including noise due to failure or aging of photographing equipment.

The density map 61 may be an image(s) indicating densities according to a region corresponding to a crowd and a non-crowd region in the crowd image 60. Such a density map 61 may represent a region corresponding to a crowd and a non-crowd region with different brightnesses or different colors.

To this end, the crowd density estimation system 200 may include an input unit 210, a storage unit 220, a control unit 230, and an output unit 240. The input unit 210, the storage unit 220, the control unit 230, and the output unit 240 may be connected to one another through a system bus, a network, or other connection mechanisms.

Information necessary for operation of the crowd density estimation system 200 according to the present invention may be input to the input unit 210. To this end, the input unit 210 may be connected with a separate input device, a server, or an external storage device, etc., via a wireless or a wired network. For example, predetermined information may be input to the input unit 210 based on a touch screen, a computer mouse, a keyboard, a keypad, a touch pad, a trackball, a joystick, a voice recognition module, other similar devices, or the like.

Accordingly, the input unit 210 may receive a crowd image 60 from a separate input device, a server, or an external storage device, etc.

In addition, in the storage unit 220, instructions and information necessary for operation of the crowd density estimation system 200 may be stored. Such a storage unit 220, as data storage, may include one or more non-transitory computer-readable storage media that may be read and/or accessed by the control unit 230 (for example, at least one of one or more processors).

In an embodiment, the crowd density estimation system 200 may be deployed (or placed) to a city control center or to a central server of a large facility such as a stadium, a subway station, or an airport. The control unit 230 may load the crowd image(s) 60 input from a plurality of cameras into queues by camera ID, and, for each queue, may generate a density map 61 of recent N frames in a sliding-window manner to track crowd density changes over time. In this case, the control unit 230, by calculating an area of a region exceeding a preset crowd density threshold value or the number of connected components in each density map, may quantify congestion of a specific section, and, when congestion exceeds a predetermined threshold value, may output a congestion alarm to a control terminal or an external alarm system.

In another embodiment, the crowd density estimation model 70 may be deployed to an edge computing device. For example, an edge device attached to a camera device, including a low-power GPU or an NPU, may transmit to a central server only summarized information such as a density map 61 or the number of persons instead of a raw crowd image. Such a configuration may significantly reduce network traffic and, while satisfying privacy protection requirements, may allow real-time crowd management.

One or more non-transitory computer-readable storage media may include volatile and/or non-volatile storage constituent elements such as optical, magnetic, organic, or other memory or disk storage devices. In some examples, the storage unit 220 may be implemented using a single physical device (for example, one optical, magnetic, organic, or other memory or disk storage device), whereas in other examples, the storage unit 220 may be implemented using two or more physical devices.

In addition, the storage unit 220 may include computer-readable instructions (directives) and additional data. The storage unit 220 may include storage necessary to perform at least a part of methods, scenarios, and techniques described in the present specification and/or at least a part of functions of devices and networks.

Accordingly, a crowd image(s) 60 and a density map 61 may be stored in the storage unit 220. In addition, in the storage unit 220, the crowd density estimation model 70 trained by the crowd density estimation model learning system 100 according to the present invention may be stored, and various data generated in a process of estimating a density map 61 from a crowd image(s) 60 by using the crowd density estimation model 70 may be stored.

The control unit 230 may control the overall operation of the crowd density estimation system 200. Such a control unit 230, as one or more processors, may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), etc.). The control unit 230 may be configured to execute computer-readable instructions (directives) included in the storage unit 220 and/or other commands described in the present specification.

Accordingly, the control unit 230, by inputting a crowd image 60 to a pre-trained crowd density estimation model 70, may estimate a density map 61 for a crowd appearing in the crowd image 60.

Specifically, the control unit 230 may receive a crowd image 60, and, by inputting the crowd image 60 to a pre-trained crowd density estimation model 70, may estimate a density map 61 for crowd appearing in the crowd image 60.

To this end, the control unit 230, by inputting a crowd image 60 to a pre-trained crowd density estimation model 70, may generate a feature vector corresponding to the crowd image 60, and may estimate a density map 61 corresponding to the feature vector.

Information generated by operation of the crowd density estimation system 200 according to the present invention may be output from the output unit 240. To this end, the output unit 240 may be connected to a separate visual output device, server, external storage device, or the like via a wireless or wired network.

For example, the output unit 240 may be configured to provide output to one or more user display devices, such as a cathode ray tube (CRT), liquid crystal display (LCD), light-emitting diode (LED), display using digital light processing (DLP) technology, or a printer. In addition, the output unit 240 may be configured to generate an audible output by using devices such as a speaker, a speaker jack, an audio output port, an audio output device, an earphone, and/or other similar devices, and may be additionally configured with one or more haptic devices capable of generating a haptic output such as vibration and/or other outputs detectable by touch and/or physical contact.

Accordingly, the output unit 240 may output a crowd image 60 and a density map 61, etc., so that a user is visually able to check through a separate output device, a server, or an external storage device, etc., and, according to embodiments, may also deliver the crowd image 60 and the density map 61, etc., to another device.

Meanwhile, the crowd density estimation system 200 may be a computing device including one or more sensors and/or a power system. Here, one or more sensors may be configured to measure conditions in the computing device and/or conditions of a computing-device environment and to provide data regarding these conditions. A power system may include one or more batteries and/or one or more external power interfaces for supplying power to the computing device.

For example, the crowd density estimation system 200 according to the present invention may be used in specific application scenarios as follows. (1) In a large performance hall or a stadium, by receiving real-time crowd images from a plurality of cameras installed around stands and entrances, a zone-wise density map 61 may be generated, and the number of persons per unit area of each zone may be estimated. The control unit 230 may determine in real time, based on this, safety operation policies such as passage closure, additional entrance opening, and guidance broadcast transmission. (2) In a transfer facility such as a subway station or an airport, by measuring congestion around platforms, stairs, and escalators, during a time period when congestion exceeds a threshold value, a message guiding a detour route or an alternative entrance may be displayed on a passenger guidance display device. In this case, the crowd density estimation system 200 may be interoperated with a traffic operation server or a passenger guidance system through a communication interface. (3) In a disaster or calamity situation, by estimating a crowd distribution from aerial images collected through a drone or a mobile camera, a deployment priority of rescue personnel may be determined, and a section in which persons are crowded may be set as a preferential search-and-rescue target. The model according to the present invention may be used as a core module supporting disaster-response decision-making since an approximate density and a movement direction of crowd may be estimated even in an environment in which visibility-obstructing factors such as inclement weather and smoke/dust are present.

Based on configurations of the crowd density estimation system 200 described above, a crowd density estimation method will be described below in more detail.

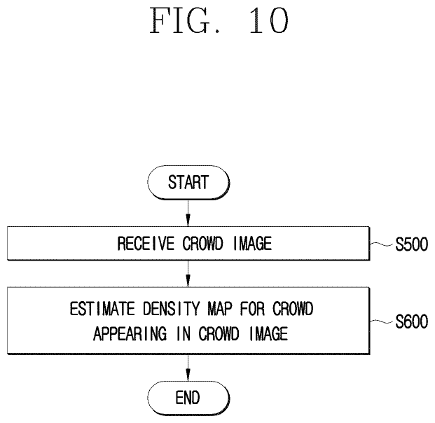

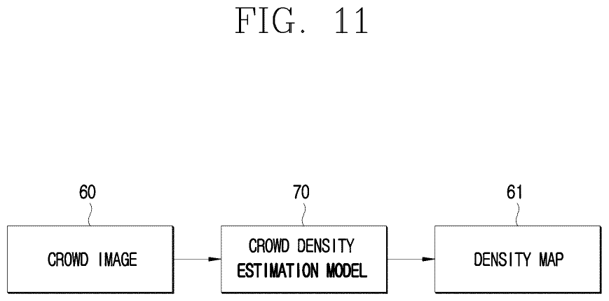

FIG. 10 is a flowchart showing a crowd density estimation method according to the present invention. FIG. 11 illustrates an embodiment of estimating a density map using the crowd density estimation model.

The pre-trained crowd density estimation model encodes representational invariance to weather-induced noise within internal feature extraction layers learned during training, such that, during inference, the crowd image is processed without requiring any additional noise detection, preprocessing, or correction operation.

Accordingly, the estimating of the density map is performed as an independent inference procedure in which robustness to environmental variations is inherently reflected in internal feature representations of the model.

With reference to FIG. 10, the crowd density estimation system 200 may receive a crowd image(s) (S500), and, by inputting the crowd image(s) to a pre-trained crowd density estimation model, may estimate a density map for a crowd appearing in the crowd image (S600).

Specifically, the crowd density estimation system 200, by inputting a crowd image to a crowd density estimation model trained according to a crowd density estimation model learning method according to the present invention, may generate a feature vector corresponding to the crowd image, and may estimate a density map corresponding to the feature vector. The estimating of the density map is executed on a parallel processing unit including at least one of a GPU or an NPU, and is configured to process a sequence of crowd images in real time, such that density maps corresponding to consecutive frames are generated with inference latency suitable for live monitoring applications.

With reference to FIG. 11, for example, the crowd density estimation model 70, when a predetermined image is input, may include a feature extraction module that generates a feature vector corresponding to the input image, and a crowd density estimation module that generates a density map corresponding to the feature vector. In this case, the feature extraction module may be configured as an encoder or a convolutional layer.

Accordingly, the crowd density estimation system 200, by inputting a crowd image 60 to the feature extraction module, may acquire a feature vector corresponding to the crowd image 60.

In addition, the crowd density estimation system 200, by inputting the previously acquired feature vector to the crowd density estimation module, may generate a density map 61 corresponding to the feature vector. To this end, the crowd density estimation module, when a feature vector generated from the feature extraction module is input, may be implemented to generate a density map corresponding to the input feature vector, and, according to embodiments, the crowd density estimation module may be deep learning models such as CNN, Transformer, Mamba, etc.

Through configurations as described above, the crowd density estimation system 200 according to the present invention, by generating a density map corresponding to an image(s) in which a crowd is photographed using a pre-trained crowd density estimation model, may grasp (or determine) in real time a crowd density and a change in crowd density according to temporal flow.

In another embodiment, noise inserted into a training crowd image may include not only a weather environment(s) but also various photographing-environment noises such as camera sensor noise, lens contamination, compression artifacts, motion blur, etc. For example, the control unit 130, by synthesizing Gaussian noise, Poisson noise, and JPEG compression noise, may generate a noise image 13, and, by labeling the same ground-truth density map 11 as a crowd image also for the noise image thus generated, may train a crowd density estimation model to be robust to hardware/software photographing-environment changes.

In still another embodiment, the crowd density estimation model 20 may be extended to a time-series network structure that processes not only still images but also video sequences as input. For example, after generating a frame-wise feature vector in the feature extraction module 21, by integrating features along a time-axis direction using LSTM, GRU, or a Temporal Convolution network, a density map considering crowd movement patterns over time may be estimated. In this case, the control unit 130, by using a ground-truth density map for consecutive T frames to additionally define a time-series loss term and by combining this with a third loss function 53, may train a crowd density estimation model in which temporal consistency is guaranteed.

In still another embodiment, the crowd density estimation model learning method according to the present invention may be applied to a problem of estimating densities of multiple objects such as vehicles, animals, things on a production line, etc., rather than a crowd. For example, by using road-traffic camera images as training images and by labeling a ground-truth density map reflecting positions of vehicles, a model for estimating vehicle density in inclement-weather or nighttime environments may be trained. Even in such a case, through weather-noise insertion and contrastive learning, a density estimation model that maintains consistent performance across diverse traffic environments may be provided.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

In an embodiment currently determined as most preferable by a present applicant, the crowd density estimation model 20 may be implemented as an encoder-decoder structure using a backbone of a ResNet family or a Swin Transformer family as the feature extraction module 21, and using an upsampling decoder of a U-Net form as the crowd density estimation module 23. An input crowd image is normalized to a 512×512 resolution in a three-channel RGB format, and the feature extraction module, including multi-stage convolutional layers and self-attention layers, may generate a feature map downsampled by 1/8 or 1/16. A decoder, by using a skip connection, may combine low-level and high-level features and, finally, may output a one-channel density map.

The contrastive learning model 30, by receiving, as input, a three-dimensional feature map output at a last stage of the feature extraction module, may be implemented to generate a one-dimensional embedding vector z through a projection head including two to three fully connected layers and a nonlinear activation function, after performing Global Average Pooling and reducing to a vector of a 1×1×C format. A first loss function may be defined as a margin-based contrastive loss, and a second loss function may be defined as a form of weighted sum of an MSE loss and an MAE loss for a density map. Training may be performed using a deep learning framework such as PyTorch or TensorFlow, with one or more GPUs, with a batch size of 8 to 32 and an epoch count ranging from 100 to 300.

Such a detailed model structure and a training environment constitute a best embodiment for reconciling crowd density estimation accuracy and learning efficiency at a current hardware/software technology level, and the present invention is not limited to the above embodiment and may be modified/extended to various network structures and training settings capable of performing equivalent functions.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the alternations within the equivalent scope of the present invention belong to the scope of the present invention.

As a result of the contrastive learning process, feature vectors generated from crowd images captured under different environmental conditions are mapped into a consistent feature space, which is reused during inference to generate stable density maps even when the input crowd image includes weather-induced noise.

What is claimed is:

1. A crowd density estimation model learning method, comprising:
receiving a training crowd image and a ground-truth density map labeled to the training crowd image, and generating a noise image by inserting noise indicating a weather environment into the training crowd image;
comparing features for the training crowd image and the noise image by using a contrastive learning model, and deriving a first loss function based on comparison results;
estimating a training density map corresponding to at least one of the training crowd image and the noise image by using a crowd density estimation model, and deriving a second loss function based on a comparison between the training density map and the ground-truth density map; and
training the crowd density estimation model by using the first loss function and the second loss function.

2. The crowd density estimation model learning method of claim 1, wherein the deriving of the first loss function comprises:
inputting respectively the training crowd image and the noise image to the crowd density estimation model to generate a first feature vector corresponding to the training crowd image and a second feature vector corresponding to the noise image;
inputting the first feature vector and the second feature vector to the contrastive learning model to generate a similarity value indicating similarity between the first feature vector and the second feature vector; and
deriving the first loss function according to a difference between the first feature vector and the second feature vector based on the similarity value for the first feature vector and the second feature vector.

3. The crowd density estimation model learning method of claim 2, wherein the contrastive learning model comprises:
a dimension reduction module configured, when the first feature vector and the second feature vector composed of three dimensions are input, to reduce dimensions of each of the input first feature vector and the input second feature vector to generate a two-dimensional first feature vector and a two-dimensional second feature vector; and
a projection head configured to convert the first feature vector and the second feature vector converted into two dimensions in the dimension reduction module into a one-dimensional first feature vector and a one-dimensional second feature vector constructed according to contrastive learning, and to compare the first feature vector and the second feature vector converted into one dimension.

4. The crowd density estimation model learning method of claim 2, wherein the deriving of the second loss function comprises:
generating the training density map corresponding to at least one of the first feature vector and the second feature vector through the crowd density estimation model; and
deriving the second loss function by comparing the training density map and the ground-truth density map.

5. The crowd density estimation model learning method of claim 4, wherein the training of the crowd density estimation model comprises:
assigning a predetermined weight to the first loss function;
deriving a third loss function by using the first loss function to which the weight is assigned and the second loss function; and
training the crowd density estimation model by using the third loss function.

6. The crowd density estimation model learning method of claim 1,
wherein the noise image is generated by inserting at least one weather-related noise selected from a group consisting of rain, snow, fog, illumination degradation, blur, and resolution degradation into the training crowd image.

7. The crowd density estimation model learning method of claim 6,
wherein the noise image is generated by superimposing a weather image having a predetermined transparency onto the training crowd image while maintaining a same resolution and channel configuration as the training crowd image.

8. The crowd density estimation model learning method of claim 2,
wherein the first feature vector and the second feature vector are generated by a same feature extraction module of the crowd density estimation model.

9. The crowd density estimation model learning method of claim 3, wherein the dimension reduction module is configured to reduce the three-dimensional feature vector by applying at least one of global average pooling, channel-wise concatenation, or a fully connected neural network.

10. The crowd density estimation model learning method of claim 1,
wherein the first loss function is derived as a contrastive loss that minimizes a distance between feature vectors corresponding to a same crowd scene and maximizes a distance between feature vectors corresponding to different crowd scenes.

11. The crowd density estimation model learning method of claim 4,
wherein the second loss function comprises at least one of a mean squared error (MSE), a mean absolute error (MAE), or a weighted combination thereof between the training density map and the ground-truth density map.

12. The crowd density estimation model learning method of claim 5,
wherein the predetermined weight assigned to the first loss function is adjusted during training such that a contribution of the first loss function is greater in an initial training stage and reduced in a later training stage.

13. A crowd density estimation model learning system, comprising:
a storage unit in which a training crowd image and a ground-truth density map labeled to the training crowd image are stored; and
a control unit configured to generate a noise image by inserting noise indicating a weather environment into the training crowd image, and to train a crowd density estimation model by using the training crowd image, the ground-truth density map, and the noise image,
wherein the control unit:
compares, by using a contrastive learning model, features for the training crowd image and the noise image;
derives a first loss function based on comparison results;
estimates, by using the crowd density estimation model, a training density map corresponding to at least one of the training crowd image and the noise image;
derives a second loss function based on a comparison between the training density map and the ground-truth density map; and
trains, by using the first loss function and the second loss function, the crowd density estimation model.

14. A program stored on a computer-readable recording medium that is executed by one or more processes in an electronic device, the program comprising instructions for performing:
receiving a training crowd image and a ground-truth density map labeled to the training crowd image, and generating a noise image by inserting noise indicating a weather environment into the training crowd image;
comparing features for the training crowd image and the noise image by using a contrastive learning model, and deriving a first loss function based on comparison results;
estimating a training density map corresponding to at least one of the training crowd image and the noise image by using a crowd density estimation model, and deriving a second loss function based on a comparison between the training density map and the ground-truth density map; and
training the crowd density estimation model by using the first loss function and the second loss function.

15. A crowd density estimation method, comprising:
receiving a crowd image; and
estimating a density map for a crowd appearing in the crowd image by inputting the crowd image to a pre-trained crowd density estimation model,
wherein the pre-trained crowd density estimation model is trained according to a crowd density estimation model learning method, and
wherein the crowd density estimation model learning method comprises:
receiving a training crowd image and a ground-truth density map labeled to the training crowd image, and generating a noise image by inserting noise indicating a weather environment into the training crowd image;
comparing features for the training crowd image and the noise image by using a contrastive learning model, and deriving a first loss function based on comparison results;
estimating a training density map corresponding to the training crowd image by using the crowd density estimation model, and deriving a second loss function based on a comparison between the training density map and the ground-truth density map; and
training the crowd density estimation model by using the first loss function and the second loss function.

16. The crowd density estimation method of claim 15,
wherein the crowd image comprises at least one image captured under an inclement weather condition including rain, snow, fog, low illumination, or sensor noise.

17. The crowd density estimation method of claim 15, wherein the estimating of the density map comprises generating a feature vector corresponding to the crowd image through a feature extraction module of the pre-trained crowd density estimation model, and generating the density map based on the feature vector.

18. The crowd density estimation method of claim 17,
wherein the feature extraction module is configured based on at least one of a convolutional neural network (CNN), a Transformer, or a Mamba-based network.

19. The crowd density estimation method of claim 15, wherein the density map represents crowd density as pixel-wise or region-wise scalar values, and a total sum of the density map corresponds to an estimated number of persons in the crowd image.

20. The crowd density estimation method of claim 15,
wherein the estimating of the density map is performed in real time for a sequence of crowd images received from at least one camera device, and the density map is used to detect a region exceeding a predetermined crowd density threshold.
